(19) United States
(12) Patent Application Publication
(10) Pub. No.: US 2005/0273373 A1
(43) Pub. Date: Dec. 8, 2005

(54) Systems, methods, and computer program products for searching and displaying low cost product availability information for a given departure-return date combination or range of departure-return date combinations

(76) Inventors: Alan Walker, Southlake, TX (US); Yanjun Zhang, Plano, TX (US); Dirk Guenther, Roanoke, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 11/133,688

(22) Filed: May 20, 2005

Related U.S. Application Data
(60) Provisional application No. 60/573,546, filed on May 21, 2004.

(51) Int. Cl. G06F 17/60

(52) U.S. Cl. 705/5

(57) ABSTRACT

The present invention generates a grid of low-priced fare combinations for either a selected departure and return date or a range of departure and return dates. The present invention uses various techniques to reduce processing and delay in generating the grids. The present invention first converts flight itineraries for the selected departure and return dates or the range of dates into the fare domain. The invention discards fare combinations that are not valid for the given travel request. The valid fare combinations are processed to determine which has the lowest fare price. The fare combinations are processed one at a time starting with the cheapest fare combination to determine which of the possible flight itineraries may be covered by the fare combination. The invention may use additional prunning steps to validate the fare combinations prior to application to individual flight itineraries. As each fare combination is matched to a flight itinerary, the grid is populated with this fare combination.

### CROSS-REFERENCE TO RELATED APPLICATION(S)

The present application claims priority from U.S. Provisional Application No. 60/573,546, filed May 21, 2004, the contents of which are incorporated herein in their entirety.

### BACKGROUND OF THE INVENTION

1. Field of the Invention

The present invention relates to the field of computerized inventory systems, such as airline reservations systems or other product and/or service reservation or inventory systems, which are used to determine availability and pricing for products and/or services. More particularly, the systems, methods, and computer program products of the present invention relate to determination of low price available products and/or services for a given departure-return date combination or range of departure-return date combinations.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline tickets, hotel reservations, car rentals, event tickets, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, AND AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, the assignee of the present invention developed an algorithm, (sometimes referred to as extended implicit enumeration algorithm), that could be used to efficiently determine the lowest fare for a travel request with specified origin, destination and dates. The algorithm used a k-shortest path schema that identified the lowest available fare that met a consumer's request and displayed this fare to the consumer. This algorithm is described more fully in U.S. patent application Ser. No. 09/421,895, filed on Oct. 21, 1999, entitled: Method and Apparatus for Searching for a Low Fare for Travel Between Two Locations, and published as a PCT application under publication number WO0129693; the contents of which are incorporated herein.

While use of the extended implicit enumeration algorithm was a major step forward in efficiently determining the lowest fare price for a given itinerary, it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. For example, let's say that there are four different flights between San Francisco and Boston that meet a consumer's input request for a given set of dates and times, and that the lowest fare flight itinerary has a layover in Salt Lake City, while the next lowest fare itinerary is only $40 more and is a direct flight. In this instance, the extended implicit enumeration algorithm would return the cheaper flight with connection through Salt Lake City to the user, but would not return the next cheapest flight. As such, the user is not aware that for an added $40 the user could take a direct flight.

Additionally, most reservation systems are configured to provide a result based on a specific itinerary requested by a user. The user is typically required to input exact dates for departure and return. However, some leisure travelers are flexible with regard to their actual dates of travel. For example, a consumer may be willing to depart or return over a range of dates, if it will make a difference in the price of airline tickets, hotel prices, event tickets, etc. Under current systems, the consumer would have to run different itinerary scenarios, take notes on each result, and then evaluate which will be the most cost effective itinerary.

Although it would be advantageous to provide different fare values to a consumer based on different flight itineraries for either a given departure and return date combination or a range of departure and return date combinations, such systems are typically difficult to implement. Specifically, there may be thousands of fares for a given itinerary. Providing a user with a lowest fare for a plurality of potential itineraries would be computational intensive and require an unacceptable amount of time to provide a solution. This problem grows exponentially, where the consumer requests itineraries for a range of departure and return date combinations. As such, systems and methods are needed that provide efficient and timely results containing a wide variety of potential itineraries to a consumer.

### BRIEF SUMMARY OF THE INVENTION

The present invention provides systems, methods, and computer program products that overcome many of the problems discussed above, as well other problems, with regard to current product availability systems. Specifically, in one embodiment, the systems, methods, and computer program products of the present invention may provide a plurality of low fare prices and different flight itinerary options for a given departure and return date combination, thereby allowing a user to view these different options and make a determination as to which fare and flight itinerary meets their goals. In an alternative embodiment, the systems, methods, and computer program products of the present invention may also provide a consumer with fare and flight itinerary options for a range of different departure and return date combinations.

Importantly, the systems, methods, and computer program products of the present invention use several pruning or discarding techniques that allow for faster, less process intensive methods to determine the lowest fare combinations for a given user travel request. Specifically, instead of processing individual flight itineraries one at a time, the systems, methods, and computer program products of the present invention initially map the individual flight itineraries that meet a consumer's travel request into the fare space, such that each flight itinerary is represented by at least one corresponding fare template. A fare template represents a pattern of fare components with specific airlines that meets the consumer's travel request. Each flight itinerary may be associated with more than one fare template. The systems, methods, and computer program products of the present invention then gather all fare combinations that correspond to each fare template. A pruning or discarding process is then initiated, whereby each fare combination is compared with the consumer's travel request. Specifically, the restrictions for each fare as outlined by the Airline Tariff Publishing Company (ATPCo) are checked against the consumer's travel requests. Those fare combinations containing restrictions that do not match the consumer's request are pruned or discarded from the search. For example, if a given fare combination requires a thirty-day advanced purchase but the consumer's request occurs less than thirty days from departure, this fare combination is pruned or discarded from further consideration. The pruning process provides a subset of fare combinations that may or may not meet the consumer's request, but have not been ruled out as of yet as they at least do not include certain fare restrictions that would prohibit their use by the consumer. (A fare may include fare restrictions on the individual flight level that eliminate the fare, but flight level restrictions are not typically checked at this point in the process.).

The extended implicit enumeration algorithm is used to process this subset of fare combinations and determine the fare combination having the lowest price. The algorithm may only find the lowest-priced fare combination, or it may create a priority queue of fare combinations in descending order by fare price. When a lowest-priced fare combination is determined, the systems, methods, and computer program products of the present then map the fare combination back into flight space.

At this point a further pruning or discarding process is applied to the fare combination. Specifically, the fare combination, in the case of a non-stop fare, or the fate's components, in the case of a fare having a layover, is initially evaluated against the different flights to see if the fare combination can be used for at least one of the flights. In this stage, the restrictions associated with the fare combination that apply a flight level are checked against the potential flights. If the fare combination does not meet any of the potential flights, it is pruned or discarded from further processing. For example, a given fare combination may have a restriction stating that it can only be used with a specific flight itinerary. If that flight itinerary is not one of the possible flight itineraries that meet the consumer's request, the fare combination is pruned or discarded from further processing. As a further example, the fare combination may be for a given booking class, e.g., Q, Y, B, M, etc. If none of the potential flight itineraries has a seat available for this class, the fare combination would be pruned.

After the fare or the fare's components has been validated for at least one flight itinerary, the systems, methods, and computer program products of the present invention then process the fare combination with each flight itinerary to determine which flight itineraries the fare combination “covers” or meets. In this process, the fare combination is compared to each flight to determine whether the fare combination may be used for the particular flight. For sake of clarity with respect to connecting flights, only legitimate connecting flights are provided as candidates for the outbound and inbound flights so that there is no need to check connection times. Instead, as part of fare validation, a check may be made as to whether a connecting flight is allowed or not allowed for a specific fare since, for example, some less expensive fares may require a connecting flight as opposed to a non-stop flight.

As a fare combination is matched with each flight itinerary, the fare combination is placed in a grid or matrix representing outbound and inbound flight combinations. As each flight is matched with a fare combination, a counter associated with the fare template corresponding to the matched flight itinerary is decremented, thereby indicating that one of the flight itineraries associated with the fare template has been satisfied. After the fare combination has been applied to all potential flight itineraries, the fare combination is discarded.

Prior to retrieving the next fare combination, the systems, methods, and computer program products of the present invention checks the counter associated with each fare template. If the counters are all zero or null, the system determines that all flight itineraries have been matched and displays the grid or matrix to the consumer. However, if some of the counters are not zero, the system retrieves the next lowest-priced fare combination from the priority queue.

The systems, methods, and computer program products may perform yet another pruning or discarding process. Specifically, the system compares information associated with the fare combination against the fare templates to see if the fare combination should be further processed. For example, the fare combination may be for a Delta Airlines flight itinerary, but all of the fare templates related with Delta flights have zero or null counters indicating that the associated flight itineraries have already been matched with a fare. As the new low-priced fare combination is of no use, the system prunes or discards this fare combination without further processing.

The above-discussed process is continued until all of the flight itineraries defined by the fare templates have been matched to a fare combination. The grid or matrix listing outbound and inbound flight itinerary combinations, along with a fare combination for each combination, is then displayed to the consumer.

The above process describes an instance where the user has requested flight information for a selected departure and return combination date. However, the systems, methods, and computer program products of the present invention are also capable of processing user requests for fare and flight information for an inputted range of possible departure and return date combinations. In this embodiment, the systems, methods, and computer program products of the present invention construct a grid containing possible departure and return date combinations. For each cell in the grid, the systems, methods, and computer program products of the present may either list one or a plurality of lowest fare combinations for a given departure and return date combination. As such, the user can easily view fare combinations for different departure and return dates and determine which fare and departure-return combination best fits their needs.

The population of the date range grid displaying fares for different departure-return date combinations is very similar to that of the grid constructed for displaying fares for a specific departure-return date combination. However, instead of mapping individual flight itineraries into the fare domain, the system maps different departure and return date combinations into the fare domain. Fares for each fare combination are then retrieved and initially pruned or discarded based on fare restrictions to provide a subset of fare combinations. Then, a lowest-priced fare combination is determined for each departure-return date combination. This lowest-priced fare combination is mapped back into the flight domain to determine either one or more flight itineraries for the given departure-return date combination that matches with the fare combination. The fare combination is then placed in a grid or matrix that indicates a lowest fare price for different departure-return dates. During this process, pruning or discarding techniques are again used to validate a fare combination for at least on departure-return date combination prior to applying the fare combination to all potential combinations. This process is continued for each departure-return date combination, until a lowest-priced fare combination has been determined for all departure-return date combinations. The grid or matrix is then displayed to the consumer.

Importantly, the systems, methods, and computer program products use a variety of pruning or discarding methods that significantly decrease processing times for fulfilling travel requests. The systems, methods, and computer program products of the present invention initially map flights into the fare space and then discard fare combinations that have restrictions that do not comply with the consumer's travel request at a fare level, thereby reducing the number of fare combinations that are applied to the low-price fare algorithm. Additionally, the systems, methods, and computer program products use a fare validation method prior to applying the fare combination to given flight itineraries in the flight domain. Specifically, the system determines whether the fare or the fare's components match at least one flight itinerary in terms of restrictions. If it does not, the fare combination is pruned or discarded without further processing.

Further, the systems, methods, and computer program products of the present invention may also use a further pruning or discarding process when applying a next lowest-priced fare combination. Specifically, after the first lowest-priced fare combination has been applied to each flight itinerary, the system determines whether all itineraries have been satisfied by the fare combination. If so, the process is discontinued and the results are displayed. If not, the system retrieves the next lowest-priced fare combination and initially checks to see whether the fare combination is applicable to any of the remaining fare templates. After validating the fare combination to at least one fare template, the system further attempts to validate the fare or the fare's components with at least one flight itinerary. If the fare combination does meet one of these pruning or discarding tests, it is discarded and not further processed.

The present invention creates graphical displays for displaying fares to a user. In one embodiment, the invention displays different fares of a given departure-return date range. In other embodiments, the present invention displays fares for a given range of departure and return date combinations.

In some embodiments, the present invention may use other criteria for selection of flights other than fare price. For example, the invention could use any measure of customer utility, such as a logit-choice model, to order the nodes in the search tree. This would bias the search towards better itineraries and away from cheaper fares that have unacceptable numbers of segments or stops.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B illustrate a typical network environment in which the systems, methods, and computer program products may be implemented according to one embodiment of the present invention.

FIG. 2 is a graphical depiction of a grid or matrix generated according to one embodiment of the systems, methods, and computer program products of the present invention illustrating various low cost fares for a given departure and return itinerary.

FIG. 3 is a graphical depiction of a grid or matrix generated according to one embodiment of the systems, methods, and computer program products of the present invention illustrating various low cost fares for a given range of departure and return dates.

FIG. 4 is an illustration of the operation flow of the systems, methods, and computer program products in response to a consumer travel request according to one embodiment of the present invention.

FIG. 5 is a graphical depiction of the mapping of flight itineraries from the flight domain to fare templates in the fare domain as performed by at least one embodiment of the systems, methods, and computer program products of the present invention.

FIG. 6 is a graphical depiction of a low-priced fare search as performed by at least one embodiment of the systems, methods, and computer program products of the present invention.

FIG. 7 is a graphical depiction of the mapping of fares from the fare domain to flight itineraries in the flight domain as performed by at least one embodiment of the systems, methods, and computer program products of the present invention.

FIG. 8 is a graphical depiction of the validation of fares to individual flights of the flight itineraries as performed by at least one embodiment of the systems, methods, and computer program products of the present invention.

FIG. 9 is a graphical depiction of the construction of flight itineraries complying with a given fare as performed by at least one embodiment of the systems, methods, and computer program products of the present invention.

FIG. 10 is a graphical depiction of the mapping of fares from the fare domain to flight itineraries in the flight domain as performed by at least one embodiment of the systems, methods, and computer program products of the present invention.

FIG. 11 is a graphical depiction of the validation of fares to individual flights of the flight itineraries as performed by at least one embodiment of the systems, methods, and computer program products of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The systems, methods, and computer program products of the present invention are described in an airline ticket reservation environment. It must be understood that this is only one example of the use of the present invention. Specifically, the systems, methods, and computer program products of the present invention can be adapted to any number of products and services and are not limited to the airline industry. For example, the present invention may be used with hotels, cruises, restaurants, car rentals, sports events, leisure activities, etc.

In addition, the below embodiments describe a system that searches for itineraries based on lowest fare. This criterion is only used to explain the aspects of the invention. It is understood that other factors could be used to determine itineraries for display. The present invention may use other criteria for selection of flights other than fare price. For example, the invention could use any measure of customer utility, such as a logit-choice model, to order the nodes in the search tree. This would bias the search towards better itineraries and away from cheaper fares that have unacceptable numbers of segments or stops.

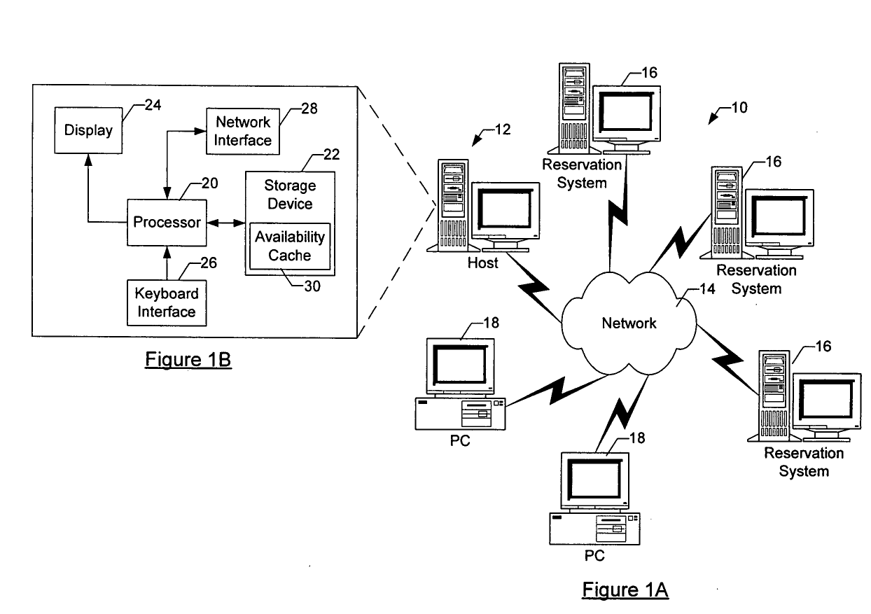

FIGS. 1A and 1B illustrate an example of a typical conventional network environment 10 in which the systems, methods, and computer program products of the present invention may be employed. The network includes a host computer 12 that operates a web site or other similar customer interface. The host computer is typically connected to a network 14, such as a LAN, WAN, Intranet, or Internet, for example. Also connected to the network are various reservation systems 16 for different products sources, such as hoteliers, airlines, car rental companies, etc. Further, customers are also connected to the network via personal computers 18 or other types of computing systems.

In operation, the travel agency, via the host computer 12, provides a web page or other similar electronic form to the customer. Using the web page, the customer inputs a travel related query. Based on this query, the host computer, in turn, polls the reservation systems 16 of the product providers for availability information. The host computer assimilates the results of these queries and provides them in a web page or other electronic form to the customer.

As illustrated in exploded FIG. 1B, the host computer system of the present invention is generally embodied as a typical computer, server or mainframe system depending on the embodiment. They system generally includes a processing element 20, such as a microprocessor, VLSI, ASIC, or other computing device, a storage device 22, display 24, keyboard and mouse interface 26, and a network interface 28.

In some embodiments, the host computer system polls the reservation system for product availability information each time a consumer enters a request. However, in some embodiments, such frequent travel requests can slow down or disrupt the reservation system. Further, accessing the reservation system may have an associated processing delay. For this reason, in some embodiments, the host computer may further include a prepopulated cache from which availability information is derived for customer requests. Specifically, as shown in FIG. 1B, the host computer system of the present invention includes an availability cache 30 located in the storage device. The availability cache is populated with various product availability information needed to properly respond to travel requests issued by customers.

It is noted here that the term customer and user may both used herein. These terms are for the most part used interchangeably. User may sometimes be used to refer to individuals or entities that maintain the system, as opposed to individuals or entities that purchase product. Further, the terms “departure dates” and “return dates” are used herein as specific to embodiments in which the product is an airline ticket. It is understood that other products with which the present invention is used may use the terms “start date of use” and “length of use.” For example, if the product is a hotel room, the start date would be the day the customer arrives, and the customer would stay for a number of nights representing a length of stay, as opposed to use of a return date.

The various operations of the present invention may be performed either by hardware in the form of ASIC chips or other specialized hardware or by operation of software ran by a processing element. In the latter case, the storage device may also further include the various computer software programs and modules used to implement the operations of the present invention.

As mentioned above and discussed in greater detail below, the systems, methods, and computer program products of the present invention provide product availability information to a consumer based on requests initiated by the consumer. Importantly, the systems, methods, and computer program products of the present invention may provide low-price fare options to a consumer for either selected dates of use or for a given range of dates of use. For example, the systems, methods, and computer program products of the present invention are suited for providing a user with airfare information. The systems, methods, and computer program products may provide a consumer with a matrix or grid of different low-priced fares that are available for a selected departure and return date combination. Alternatively, the systems, methods, and computer program products of the present invention may provide a grid or matrix that lists a plurality of different departure and return date combinations. For each, departure-return combination, a determined, low-priced available fare is provided.

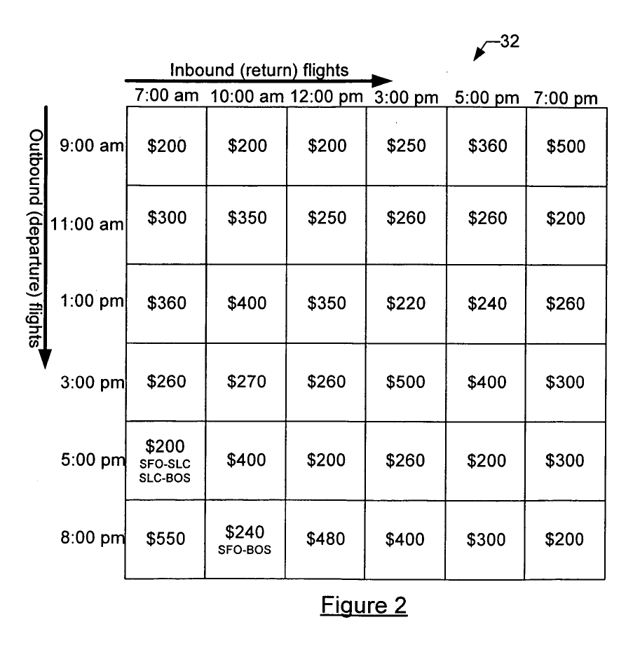

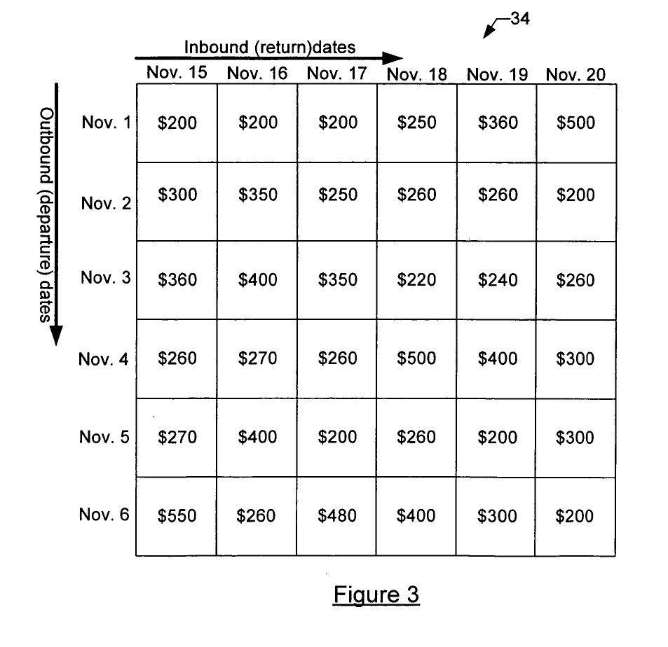

FIGS. 2 and 3 respectively illustrate these two optional result pages that may be produced using the systems, methods, and computer program products of the present invention. Specifically, FIG. 2 illustrates a results grid or matrix 32 for a selected departure, e.g., November 1, and return date, e.g., November 12. The rows of the grid represent outbound flights for the November 1 departure date, while the columns represent inbound flights for the November 12 return date. Each cell of the grid represents an itinerary for a given outbound and inbound flight combination. Further, each cell is populated with a lowest available fare the given outbound and inbound combination. By studying this grid 32, a consumer can review all of the different flight itinerary combinations and the different prices and make an informed decision concerning choice of flight itineraries. For example, the grid discloses that there is a flight leaving at 7:00 am that connects through Salt Lake City and returns at 5:00 pm for $200 and there is a direct flight that leaves at 10:00 am and returns at 8:00 pm for $240. Given both of these options, the consumer can determine which of these flight itineraries meet his/her needs either in terms of price or convenience.

FIG. 3 is somewhat different than FIG. 2 in that this grid 34 illustrates various low cost fares for a range of departure and return date combinations. The rows of the grid represent different return dates, e.g., November 15-20, while the columns represent different departure dates, e.g., November 1-6. Here again, a consumer can view the various available fares for the different departure and return date combinations and determine which of these solutions is acceptable in terms of price and/or convenience. Generation of each of these grids is discussed in turn below.

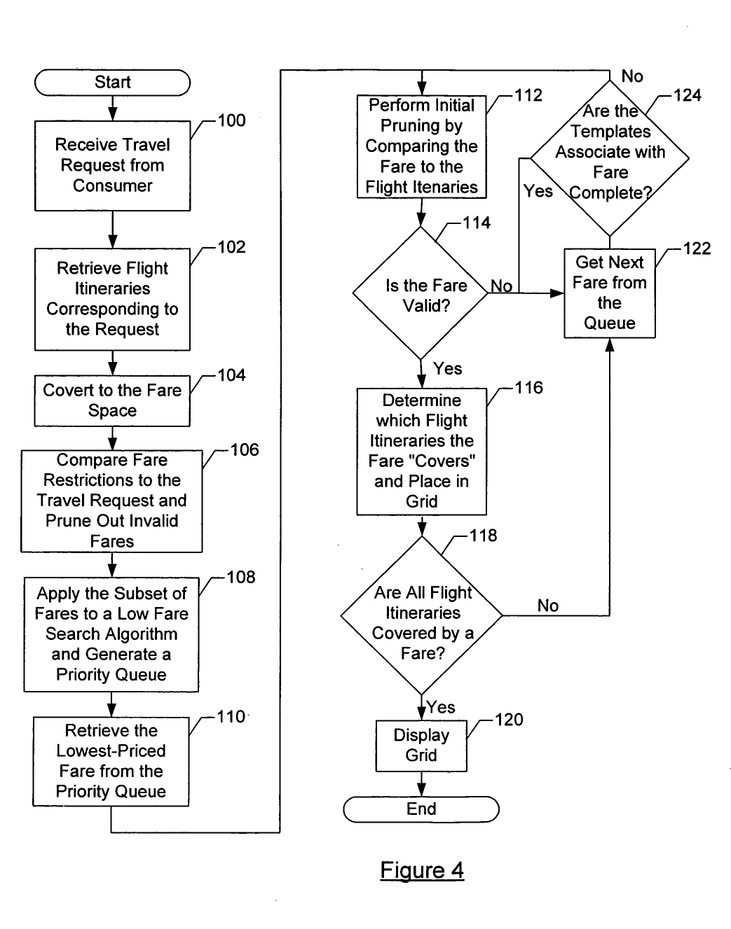

FIG. 4 is a generalized illustration of the operations performed by the systems, methods, and computer program products of the present invention to generate either of the grids or matrices, 32 and 34, illustrated respectively in FIGS. 2 and 3. The description of this generalized operation is given by example to the grid of FIG. 2 for a specific departure and return date combination, with differences in operation being noted for generation of the grid of FIG. 3.

In a general manner, the systems, methods, and computer program products of the present invention initially receives a travel request from a consumer for airfares for a travel plan. In this embodiment, the user inputs a specific departure and return date combination. See block 100. The system, e.g., host computer, uses information from the request and retrieves flight itineraries corresponding to the request. See block 102. To generate the grid or matrix 32 of FIG. 2, the system then converts these flight itineraries into fare space and generates a series of fare templates. See block 104. To generate the grid or matrix 34 of FIG. 3, the system converts departure-return date combinations into fare space.

Once in fare space, the system performs an initial pruning or discarding process by comparing the restrictions associated with each fare combination as defined by the different categories of ATPCo to the consumer's travel request. See block 106. The comparison is performed at the fare level, as such, some fare combinations may be passed at this stage, but determined later to be invalid when applied to the actual flight itineraries. From this pruning process, a subset of fare combinations is produced. For the grid of FIG. 2, this involves comparing the fare combinations to the selected departure and return date combination requested by the consumer. For the grid of FIG. 3, this involves comparing each fare combination to different departure-return date combinations, where the fare combination may be valid for some departure-return date combinations, but not others. If it is valid for any of the departure-return date combination, it is retained. Although ATPCo categories are mentioned in this example, categories from other organizations, such as for example SITA, could be used with the present invention.

The system next applies the subset of fare combinations to a low fare search algorithm to determine which of the fare combinations provides the lowest available price. See block 108. In some embodiments, the system may either generate only the lowest-price fare combination, or it may instead generate a priority queue listing in descending order the fare combinations by price. Further, although the system may use any low fare search algorithm, in some embodiments, the extended implicit enumeration algorithm developed by the assignee of the present invention is used. Note here that criteria other than price may be used for selecting itineraries.

After the lowest-priced fare combinations have been determined, the systems, methods, and computer program products of the present invention then attempt to apply the fare combinations one at a time to the flight itineraries associated with the fare templates in the flight space. See blocks 110-116. (For the grid of FIG. 3, the system would apply each fare combination to each departure-return date combination and each flight for each departure-return combination.) For each fare combination, however, the system performs a second pruning or discarding procedure. Specifically, the system first retrieves the lowest-priced fare combination from the priority queue. See block 110. The system first attempts to validate the fare or the components of the fare in the case of a fare having connecting flights. See block 112. The system compares the restrictions associated with the fare combination to each of the flights and determines if the fare combination may be valid for any of the flights. If the fare combination does not match with any of the flights in the pruning process, it is discarded. See block 114.

After the fare combination has been validated for at least one flight itinerary, the systems, methods, and computer program products of the present invention then process the fare combination with each flight itinerary to determine which flight itineraries the fare combination “covers” or meets. See block 116. In this process, the fare combination is compared to each flight to determine whether the fare combination may be used for the particular flight. As a fare combination is matched with each flight itinerary, the fare combination is placed in a grid or matrix representing outbound and inbound flight combinations. See block 116. (For the grid of FIG. 3, as each fare combination is matched with a flight for a given departure-return date combination, the fare combination is placed in the grid.)

As each flight is matched with a fare combination, a counter associated with the fare template corresponding to the matched flight itinerary is decremented, thereby indicating that one of the flight itineraries associated with the fare template has been satisfied. After the fare combination has been applied to all potential flight itineraries, the fare combination is discarded.

Prior to retrieving the next fare combination, the systems, methods, and computer program products of the present invention checks the counter associated with each fare template. If the counters are all zero or null, the system determines that all flight itineraries have been matched and displays the grid or matrix to the consumer. See blocks 118 and 120. However, if some of the counters are not zero, the system retrieves the next lowest-priced fare combination from the priority queue. See block 122.

The systems, methods, and computer program products may perform yet another pruning or discarding process. Specifically, the system compares information associated with the fare combination against the fare templates to see if the fare should be further processed. See block 124. For example, the fare combination may be for a Delta Airlines flight itinerary, but all of the fare templates related with Delta flights have zero or null counters indicating that the associated flight itineraries have already been matched with a fare combination. As the new low-priced fare combination is of no use, the system prunes or discards this fare combination without further processing.

If the fare combination is valid based on this pruning process, the system then attempts to match it to flight itineraries. See blocks 112-116. This process is continued until all flight itineraries are covered by a fare combination. See block 118. The grid or matrix is then displayed to the consumer. See block 120.

The system does not generate all fares for display. Once a fare has been matched for a combination, further fares for the combination are not checked. The system thus generates less combinations of fares and reduces computing time by using the counters associated with each fare template.

FIG. 4 is a generalized version of the operations performed to create the grids, 32 and 34, respectively illustrated in FIGS. 2 and 3. Provided below are detailed examples of these two processes. It must be understood that these are specific examples that are provided as an illustration of the systems, methods, and computer program products of the present invention. These examples do not define the only way in which the invention operates.

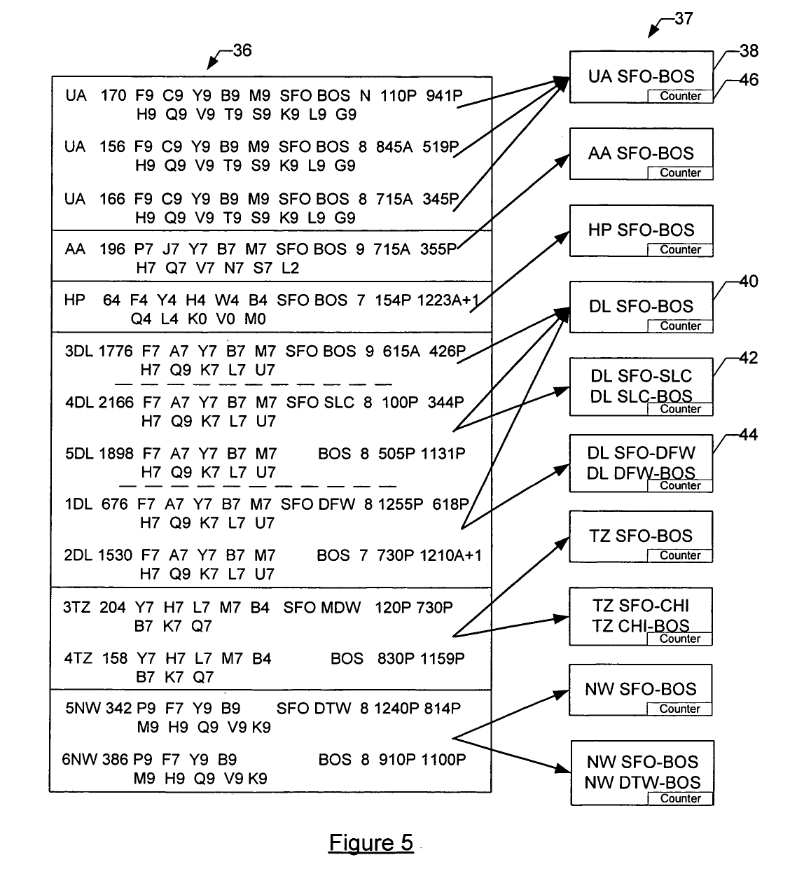

With reference to FIGS. 1A, 1B, and 4, to generate a grid 32 similar to that of FIG. 2 of low fare options for selected departure and return dates, a consumer initially inputs a departure date/time and return date/time, number of passengers, and/or class of ticket requested, etc. See block 100. Based on this entered request, the host computer either accesses its associated cache or contacts the appropriate computer reservation system and receives a list of itineraries that correspond to the consumer's selected information. For example, FIG. 5 illustrates a series of itineraries 36 for travel between San Francisco and Boston. Some of the itineraries include non-stop flights, while others have layovers, such as Salt Lake City or Dallas-Fort Worth. Further, the flights are from different airlines, i.e., United Airlines UA, American Airlines AA, American West HP, Delta DL, etc. Using these different flights, the systems, methods, and computer program products of the present invention determine a plurality of lowest fare combinations for different departure and return flight combinations.

With reference to FIGS. 4 and 5, the host computer system initially converts the various flights into the fare domain. See block 104. Specifically, the host computer generates a series of fare templates 37. These fare templates are created from the possible fare break points. The fare templates are used to represent commonalities in the itineraries. These fare templates will be processed to determine low fare combinations, as opposed to processing of each individual flight itinerary.

For example, the fare templates 37 are used to represent one or more of the flights 36 in the fare domain. For example, fare template 38 represents non-stop United Airlines flights between San Francisco and Boston; fare template 40 represents non-stop Delta flights between San Francisco and Boston; and fare template 42 represents all Delta flights with layovers in Salt Lake City. The host computer then maps each flight into the different fare templates that may apply.

For example, the three listed United Airline flights are all non-stop. As such, each of the flights can be represented by the fare template 38. The treatment of Delta flights is important to note. Specifically, as illustrated, the first Delta flight is a non-stop flight and therefore will map to the Delta non-stop fare template 40. The second Delta flight has a layover is Salt Lake City. This flight itinerary is mapped to both the Delta non-stop fare template 40 and the fare template 42 indicating a layover in Salt Lake City. The third Delta flight has a layover in Dallas-Fort Worth. This flight itinerary is mapped both to the Delta non-stop fare template 40 and the fare template 44 indicating a layover in Dallas-Fort Worth.

As illustrated, each of the flight itineraries is mapped into one or more of the fare templates. Importantly, each of the fare templates 37 includes an associated counter 46. During the conversion process, the host computer maintains a count for each template of the number of flight itineraries that are associated with each fare template. For example, in the present scenario, the United Airlines non-stop flight fare template 38 would have an initial count of three (3), as it represents the three different United Airlines' flights. Similarly, the Delta non-stop fare template 42 would also have an initial count of three (3), while the Delta fare template 44 for the layover is Salt Lake City would have an initial count of one (1). As will be explained later, these counters are used during the conversion from fare space back to flight space.

Following generation of the fare templates, the systems, methods, and computer program products of the present invention next perform a pruning process in an attempt to eliminate those fare combinations that due to certain ATPCo restrictions do not apply to the flight itinerary request made by the consumer. See block 106. It is important to remove these fare combinations prior to application of the fare combinations to a low-fare search algorithm. For this reason, the systems, methods, and computer program products of the present invention initially compare each of the fare combinations to the ATPCo fare level flight restrictions. A complete listing of ATPCo fare restrictions is available at www.atpco.net.

For example, the host computer may compare the booking class, e.g., such as F, C, Q, Y, B, M, etc., for each fare combination to the booking class selected by the user. All those fare combinations that do not coincide with the selected class or classes are discarded. Further, the host computer may review other fare level restrictions such as advance purchase, passenger type, effective/discontinue dates, etc. so as to discard all fare combinations that will not be applicable to the consumer's request.

After the pruning process, the systems, methods, and computer program products of the present invention next apply the remaining subset of fare combinations to a lowest-fare search algorithm to determine which of the subset has the lowest price. See block 108. (Here again, criteria other than fare price can be used to determine itineraries that meet the user's request.) It must be understood here that any lowest-fare search algorithm could be employed. For example purposes, the extended implicit enumeration algorithm developed by the assignee of the present invention is used herein to illustrate the low-fare search process.

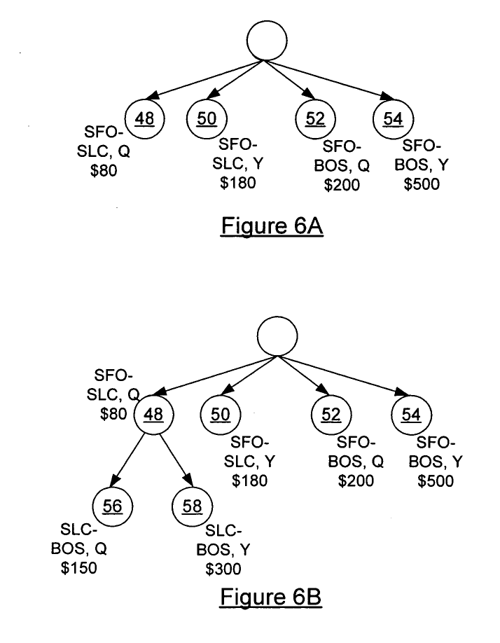

As is detailed more fully in the Ser. No. 09/421,895 application, the extended implicit enumeration algorithm uses a k-shortest path to determine the lowest price fare combination from a group of fare combinations. FIGS. 6A-6B illustrate an example of the use of the algorithm implemented for the current invention. Specifically, FIG. 6A illustrates a set of nodes 48-54 representing different fare combinations that may be used for a round trip flight itinerary from San Francisco to Boston. Node 48 represents a fare from San Francisco to Salt Lake City for $80, while node 52 is a non-stop fare for $200. In this instance, the current shortest path, i.e., the cheapest path, is the $80 fare of node 48. However, this node only represents a fare from San Francisco to Salt Lake City, and therefore must be expanded so as to represent a fare combination to Boston.

In FIG. 6B, the node 48 is expanded by the extended implicit algorithm to reveal that the fare may be combined with two different fares, nodes 56-58, representing flights from Salt Lake City to Boston. As illustrated, these two nodes each have associated fares that when combined with the fare of node 48 exceeds the $200 fare associated with node 52. The extended implicit enumeration algorithm notes this and determines that node 48 is not the lowest cost fare. The algorithm would them attempt to expand node 50, as it is now the cheapest fare.

While not discussed here, the extended implicit enumerated algorithm may use a lower bounding limit for the cost of getting from an intermediate node, i.e., Salt Lake City, to a terminal node, i.e., Boston. For example, in the present scenario regarding node 50, it is highly unlikely that there is a fare for less than $20 between Salt Lake City and Boston. The likelihood of such a fare is remote. Therefore, the algorithm may set a lower bound of $150 for the node. This lower bound is usually determined based on passed fare histories for the node. In this instance, the algorithm would not waste processing time expanding node 50. Instead, the algorithm would determine that the lowest cost fare is the $200 fare represented by node 52.

With regard to FIG. 4, the systems, methods, and computer program products of the present invention apply each of the fare combinations to the low-fare search algorithm and create a priority queue of fare combinations in descending order of price. See block 108.

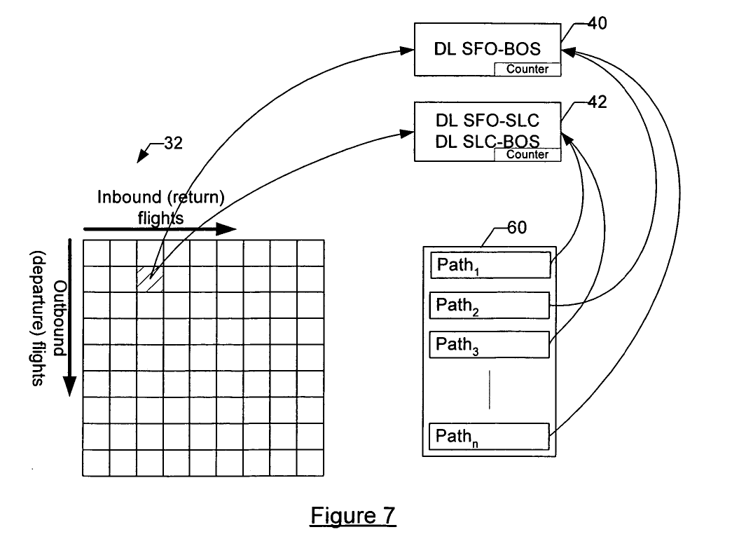

Once the fare combinations have been prioritized in this manner, the fare combinations are then one at a time converted to flight space and matched to specific flights. Specifically, FIG. 7 illustrates a grid or matrix 32 similar to that of FIG. 2 having cells each representing different inbound and outbound flight combinations 40 and 42. Also illustrated in FIG. 7, is the priority queue 60 listing all of the various fare paths Path₁₋ₙ in descending order in terms of fare price. The arrows illustrate matching of fare combinations with flight itineraries.

Specifically, with regard to FIG. 4 and FIG. 8, the systems, methods, and computer program products of the present invention first validates the fare combination to at least one flight based on the flight level restrictions associated with the fare combination. See block 112. Flight level restrictions refer to restrictions in a given fare that will not allow the fare to be used for certain flights. Specifically, if the fare combination comprises two nodes, e.g., San Francisco to Salt Lake City and Salt Lake City to Boston, the fare combination is split into its two fare components and the present invention attempts to validate each fare component to at least one of the flights. If the fare component does not validate against any of the flights, it is discarded to save processing time. See block 114. It is noted here that if the fare combination is for a non-stop flight, it will only have one fare component. Similarly, if the fare combination had two layovers, it would have three (3) fare components that are each validated.

A number of rules can be used to find a flight that validates the fare component. For example, the booking code, booking code exception, flight application, day/time, routing, etc. associated with the fare component may be checked against the flights.

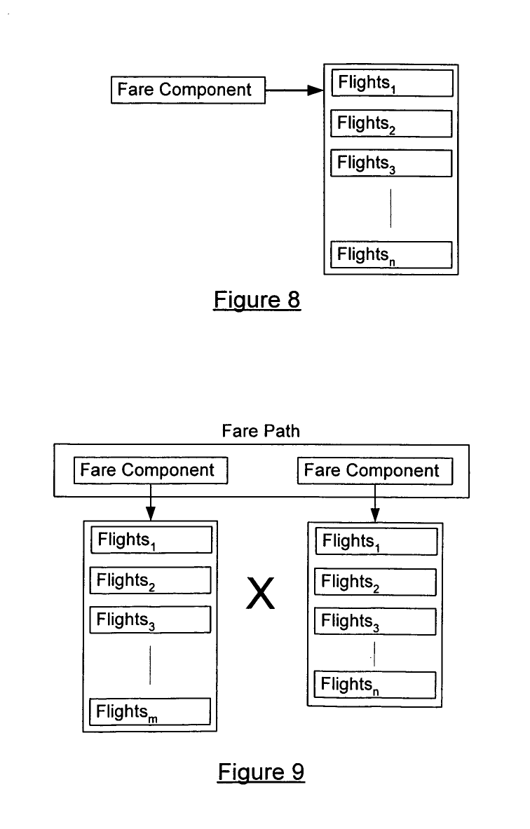

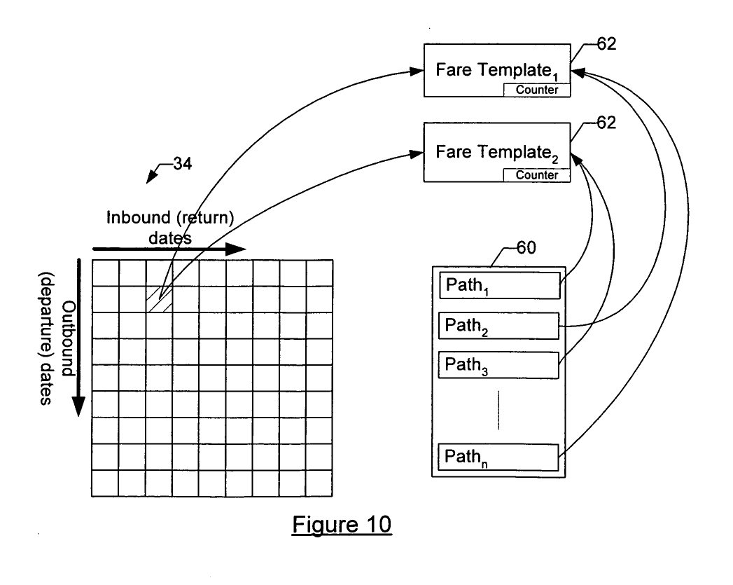

With reference to FIGS. 4, 7, and 9, after the fare components have been validated against at least one flight, the systems, methods, and computer program products of the present invention next determine which of the flights are “covered” or match the fare combination. In this regard, each fare component may match to different flights. The present invention determines those flights that match with each other to create a valid itinerary. See block 116.

As the fare combination is matched with each flight itinerary, the cell in the grid or matrix associated with the flight itinerary is populated with the fare combination. See block 116. Additionally, as each flight itinerary is matched with the fare combination, the counter associated with the flight itinerary is decremented. For example, as illustrated in FIG. 7, during the first pass, the first fare Path₁ in the priority queue matches with the Delta flight itinerary for San Francisco to Salt Lake City and Salt Lake City to Boston. In this instance, the counter associated with the fare template 42 is decremented from one to zero indicating that the flight itineraries covered by the fare template have been satisfied. Further, because the flight associated with the fare template 42 is also mapped to the Delta non-stop fare template 40, the counter of this fare template 40 is also decremented, such that it would now indicate that two flight itineraries associated with the template have not been matched to a fare combination.

With reference to FIG. 4, after first fare path Path₁, in the priority queue has been applied to all possible flight itineraries, the fare path is discarded, and a next lowest-priced fare Path₂ is retrieved from the priority queue for processing. See block 122. It is noted here that this example implies that the system generates all of the low cost fare combinations in order and places them in the priority queue prior to applying the fare combinations to the flight itineraries. This, however, is not always the case. Specifically, for example, the system could only generate one lowest-cost fare combination at a time and apply it to the flight itineraries. In this instance, a second lowest-cost fare combination would only be generated if the first lowest-cost fare combination did not apply or “cover” all flights. In another embodiment, the system may generate a first limited number of low-cost fare combinations and then only generate more if the first set did not “cover” all of the flight itineraries.

With reference to FIG. 4, when the next fare path Path₂ is retrieved, the systems, methods, and computer program products may perform yet another pruning process. See block 124. Specifically, the system may initially look at the airline associated with the fare path. If the fare path is for a Delta flight, but the counters for the Delta fare templates indicate that all Delta flight itineraries have been covered, the system will discard the fare path without performing additional processing. As a further example, as illustrated in FIG. 7, the first fare path Path₁ covered the flight itinerary associated with the fare template 42 and its associated counter was decremented to zero. If the second fare path Path₂ is also for a flight itinerary connecting through Salt Lake City, the system will discard the second fare path, as flight itineraries for flights connecting through Salt Lake City have already been covered.

The process outlined in FIG. 4 is continued until all of the flight itineraries in the grid or matrix have been covered; at which time the program terminates, and the grid or matrix is displayed to the user. See blocks 118 and 120.

The process for generating the grid or matrix illustrated in FIG. 3 for a range of departure and return dates is similar to the process for creating the grid or matrix 32 of FIG. 2. However, instead of populating the grid with different fare combinations for different flight itineraries for a selected departure and return date, the system populates each cell of the grid with a fare combination for a given departure-return date combination.

With reference to FIGS. 1A, 1B, and 4, to generate a grid 34 similar to that of FIG. 3 of low fare combination options for a range of departure and return date combinations, a consumer initially inputs a range of departure and return date, number of passengers, and/or class of ticket requested, etc. See block 100. Based on this entered request, the host computer either accesses its associated cache or contacts the appropriate computer reservation system and receives a list of itineraries that correspond to the consumer's selected information. The list of itineraries will include all possible flight itineraries for each departure-return combination. The host computer system initially converts the various flight itineraries into the fare domain. See block 104. Specifically, the host computer generates a series of fare templates. These fare templates are created from the possible fare break points. The fare templates are used to represent commonalities in the flight itineraries. These fare templates will be processed to determine low fare combinations, as opposed to processing of each individual flight itinerary.

Importantly, each of the fare templates includes an associated counter. During the conversion process, the host computer maintains a count for each template of the number of flight itineraries that are associated with each fare template. These counters are used during the conversion from fare space back to flight space.

Following generation of the fare templates, the systems, methods, and computer program products of the present invention next perform a pruning process in an attempt to eliminate those fare combinations that due to certain ATPCo restrictions do not apply to the flight itinerary request made by the consumer. See block 106. It is important to remove these fare combinations prior to application of the fare combinations to a low-fare search algorithm. For this reason, the systems, methods, and computer program products of the present invention initially compare each of the fare combinations to the ATPCo fare level flight restrictions. A complete listing of ATPCo fare restrictions is available at www.atpco.net.

For example, the host computer may compare the booking class, e.g., such as F, C, Q, Y, B, M, etc., for each fare combination to the booking class selected by the user. All those fare combinations that do not coincide with the selected class or classes are discarded. Further, the host computer may review advance purchase, passenger type, effective/discontinue dates, etc. so as to discard all fare combinations that will not be applicable to the consumer's request.

Because the system is reviewing series of different departure-return combinations, it is possible that some fare combinations will be valid for some combinations, but not others. For example, some fare combinations may require a Saturday night stay. In instances where the return date occurs after a Saturday, this fare combination will apply, but it will not apply to those combinations that do not include a Saturday night stay. As such, a given fare combination need only be validated for one departure-return combination to remain under consideration.

After the pruning process, the systems, methods, and computer program products of the present invention next apply the remaining subset of fare combinations to a lowest-fare search algorithm to determine which of the subset has the lowest price. See block 108. The system creates a priority queue of fare combinations in descending order of price. See block 108.

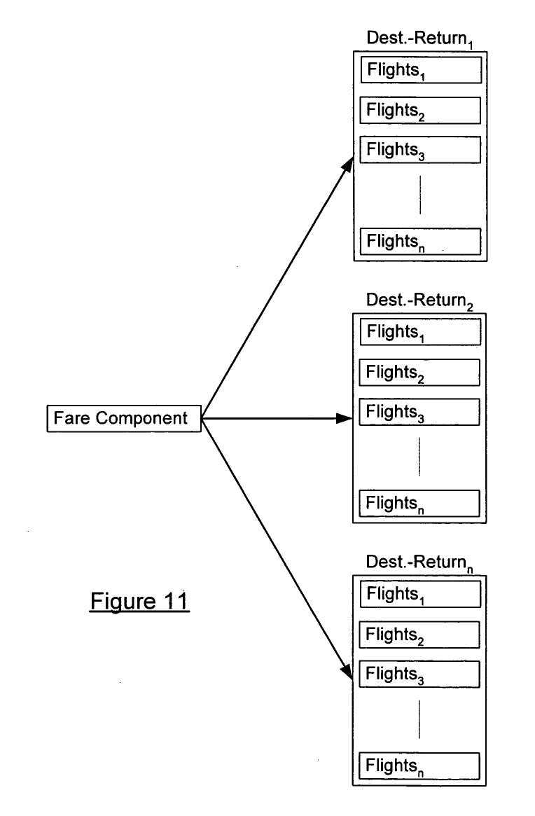

Once the fare combinations have been prioritized in this manner, the fare combinations are then one at a time converted to flight space and compared to specific flight itineraries for each departure-return date combination. Specifically, FIG. 10 illustrates a grid or matrix 34 similar to that of FIG. 3 having cells each representing different departure and return date combinations. Each departure-return combination is represented by a plurality of fare templates 62, which in turn, represents the various flight itineraries available for the departure-return date combination. Also illustrated in FIG. 8, is the priority queue 60 listing all of the various fare paths Path₁₋ₙ in descending order in terms of fare price. The arrows illustrate matching of fare combinations with flight itineraries.

Specifically, with regard to FIG. 4 and FIG. 11, the systems, methods, and computer program products of the present invention first validates the fare combination to at least on flight itinerary for at least one departure-return date combination based on the restrictions associated with the fare combination. See block 112. Specifically, if the fare combination comprises two nodes, e.g., San Francisco to Salt Lake City and Salt Lake City to Boston, the fare combination is split into its two fare components and the present invention attempts to validate each fare component to at least one of the flights. If the fare component does not validate against any of the flights, it is discarded to save processing time. See block 114.

A number of rules can be used to find a flight that validates the fare component. For example, the booking code, booking code exception, flight application, day/time, routing, etc. associated with the fare component may be checked against the flights.

With reference to FIGS. 4, 7, and 9, after the fare components have been validated against at least one flight itinerary for one departure-return date combination, the systems, methods, and computer program products of the present invention next determine at least one flight itinerary for each departure-return date is “covered” or match the fare combination. In this regard, each fare component may match to different flights. The present invention determines those flights that match with each other to create a valid itinerary. See block 116. In some embodiments, the system may only determine one fare-flight itinerary match for each departure-return combination, or it may determine all fare-flight itinerary matches for each departure-return combination for the given fare combination.

As the fare combination is matched with a flight itinerary for a given departure-return combination, the cell in the grid or matrix associated with the departure-return combination is populated with the fare combination. See block 116. Additionally, as each departure-return combination is matched with the fare combination, the counter associated with the fare template associated with the combination is decremented.

With reference to FIG. 4, after first fare path Path₁ in the priority queue has been applied to all possible flight itineraries for each departure-return combination, the fare path is discarded, and a next lowest-priced fare Path₂ is retrieved from the priority queue for processing. See block 122. When the next fare path Path₂ is retrieved, the systems, methods, and computer program products may perform yet another pruning process. See block 124. Specifically, the system may initially look at the restrictions associated with the fare path. If the fare path is only valid for departure-return dates that have a Saturday night stay, but all such combinations have already been satisfied, the system will discard the fare path without performing additional processing. The process outlined in FIG. 4 is continued until all of the departure-return combinations in the grid or matrix 34 have been covered; at which time the program terminates, and the grid or matrix is displayed to the user. See blocks 118 and 120.

As described in conjunction with the population of the various grids or matrices, the process may be continued until the grid or matrix is fully populated. However, the grid or matrix need not be fully populated and, in one embodiment, a threshold is defined such that the population of the grid or matrix is terminated once the threshold is met. For example, as the population of the grid or matrix generally proceeds from entries having lower fares to entries having higher fares, a fare threshold may be established, such as x % of the lowest fare in the grid or matrix, such that those entries that would have a fare greater than the fare threshold need not be added to the grid or matrix, thereby permitting the process to be terminated once the fare threshold has been met. By way of a specific example, consider that the fare threshold is 150% of the fare of the entry in the grid or matrix having the lowest fare. If the lowest fare of an entry in the grid or matrix is $100, once an entry to the grid or matrix has a fare of $150, the process may be terminated without completing the remainder of the grid or matrix so as to save processing resources and time since the consumer is believed not to be interested in the higher priced flights.

In addition to providing apparatus and methods, the present invention also provides computer program products for performing the operations described above. The computer program products have a computer readable storage medium having computer readable program code means embodied in the medium. With reference to FIG. 1B, the computer readable storage medium may be part of the storage device 22, not shown, and may implement the computer readable program code means to perform the above discussed operations.

In this regard, FIGS. 1-11 are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for generating a grid of fare combinations for a travel request comprising:
an interface for receiving a travel request from a user;
one or more product sources providing travel products; and
a processor in communication with said interface and product sources, wherein said processor is configured to:
retrieve flight itineraries associated with the travel request;
convert the flight itineraries into a fare domain to create fair combinations;
compare at least one first fare restriction associated with each fare combination to the travel request;
discard fare combinations that do not comply with the travel request to create a subset of fare combinations;
rank the subset of fare combinations based on one or more selected criteria; and
process each fare combination one at a time to determine which flight itineraries for the travel request are covered by the fare combination.

2. A system according to claim 1, wherein the selected criteria is price and said processor ranks the subset of fares based on price.

3. A system according to claim 2, wherein said processor determines a list of lowest priced fare combinations and creates a queue listing the fare combinations from lowest in price to highest in price, and wherein said processor processes each fare combination in the queue starting with the lowest priced fare in the queue until all flight itineraries for the selected departure-return date combination are covered by at least one fare combination.

4. A system according to claim 1, wherein the selected criteria is number of stops and said processor ranks the subset of fares based on the number of stops associated with each fare.

5. A system according to claim 1, wherein said processor determines a list of fare combinations and creates a queue listing the fare combinations based on the one or more selected criteria, and wherein said processor processes each fare combination in the queue starting with the first fare combination in the queue until all flight itineraries for the travel request are covered by at least one fare combination.

6. A system according to claim 1, wherein the travel request includes a selected departure-return date combination, wherein said processor compares fare restrictions associated with each fare combination to at least the dates of the selected departure-return date combination, and discards fare combinations that do not comply with at least the dates of the selected departure-return date combination to create a subset of fare combinations.

7. A system according to claim 1, wherein said processor after ranking the fares:
compares at least one second fare restriction associated with each fare combination to the travel request; and
discards fare combinations that do not comply with the travel request.

8. A system according to claim 1, wherein the one or more first fare restrictions are fare level restrictions associated with the fare.

9. A system according to claim 8, wherein the at least one second fare restriction is a flight level restriction associated with the fare.

10. A system according to claim 1, wherein each fare template represents a pattern of fare components with respective airlines that meets the user's travel request, said processor for each fare template, creates a count of the number of flight itineraries that correspond to the given fare template.

11. A system according to claim 10, wherein said processor decrements a counter associated with a fare template, when a flight itinerary corresponding to the fare template is matched with a fare combination.

12. A system according to claim 10, wherein said processor for each fare combination determines the fare template corresponding to the fare combination and determines the value of the counter associated with the corresponding fare template, wherein if the counter value is zero, said processor discards the fare combination without further processing.

13. A system according to claim 1, wherein the travel request is for a selected departure-return date combination, wherein said processor processes each fare combination one at a time to determine which flight itineraries for the selected departure-return data combination are covered by the fare combination.

14. A system according to claim 13, wherein said processor displays in a grid fare prices representing different flight itineraries for the selected departure-return date combination.

15. A system according to claim 1, wherein the travel request is for a range of selected departure-return date combinations, wherein said processor processes each fare combination one at a time to determine which flight itineraries for the selected departure-return date combinations are covered by the fare combination.

16. A system according to claim 15, wherein said processor displays in a grid fare prices representing different flight itineraries for the selected departure-return date combination.

17. A method for generating a grid of fare combinations for a travel request comprising:
retrieving flight itineraries associated with the travel request;
converting the flight itineraries into a fare domain to create fair combinations;
comparing at least one first fare restriction associated with each fare combination to the travel request;
discarding fare combinations that do not comply with the travel request to create a subset of fare combinations;
ranking the subset of fare combinations based on one or more selected criteria; and
processing each fare combination one at a time to determine which flight itineraries for the travel request are covered by the fare combination,
wherein at least one of said retrieving, converting, comparing, discarding, ranking and processing steps is performed by a processing element.

18. A method according to claim 17, wherein the selected criteria is price and said ranking step comprises ranking the subset of fares based on price.

19. A method according to claim 18, wherein said ranking step determines a list of lowest priced fare combinations and creates a queue listing the fare combinations from lowest in price to highest in price, and wherein said processing step processes each fare combination in the queue starting with the lowest priced fare in the queue until all flight itineraries for the selected departure-return date combination are covered by at least one fare combination.

20. A method according to claim 17, wherein the selected criteria is number of stops and said ranking step comprises ranking the subset of fares based on the number of stops associated with each fare.

21. A method according to claim 17, wherein said ranking step determines a list of fare combinations and creates a queue listing the fare combinations based on the one or more selected criteria, and wherein said processing step processes each fare combination in the queue starting with the first fare combination in the queue until all flight itineraries for the travel request are covered by at least one fare combination.

22. A method according to claim 17, wherein the travel request includes a selected departure-return date combination, wherein said comparing step compares fare restrictions associated with each fare combination to at least the dates of the selected departure-return date combination, and said discarding step discards fare combinations that do not comply with at least the dates of the selected departure-return date combination to create a subset of fare combinations.

23. A method according to claim 17 further comprising after said ranking step and before said processing step, the steps of:
comparing at least one second fare restriction associated with each fare combination to the travel request; and
discarding fare combinations that do not comply with the travel request.

24. A method according to claim 17, wherein the one or more first fare restrictions are fare level restrictions associated with the fare.

25. A method according to claim 23, wherein the at least one second fare restriction is a flight level restriction associated with the fare.

26. A method according to claim 17, wherein each fare template represents a pattern of fare components with respective airlines that meets the user's travel request, said method further comprising for each fare template, creating a count of the number of flight itineraries that correspond to the given fare template.

27. A method according to claim 26 further comprising decrementing a counter associated with a fare template, when a flight itinerary corresponding to the fare template is matched with a fare combination.

28. A method according to claim 27, wherein said processing step for each fare combination determines the fare template corresponding to the fare combination and determines the value of the counter associated with the corresponding fare template, wherein if the counter value is zero, said processing step discards the fare combination without further processing.

29. A method according to claim 17, wherein the travel request is for a selected departure-return date combination, wherein said processing step processes each fare combination one at a time to determine which flight itineraries for the selected departure-return data combination are covered by the fare combination.

30. A method according to claim 28 further comprising displaying in a grid fare prices representing different flight itineraries for the selected departure-return date combination.

31. A method according to claim 17, wherein the travel request is for a range of selected departure-return date combinations, wherein said processing step processes each fare combination one at a time to determine which flight itineraries for the selected departure-return date combinations are covered by the fare combination.

32. A method according to claim 31 further comprising displaying in a grid fare prices representing different flight itineraries for the selected departure-return date combination.

33. A computer program product for generating a grid of fare combinations for a travel request, said computer program product comprising a computer-readable storage medium having computer-readable program code portions stored therein, the computer-readable program code portions comprising:
first computer instruction means for retrieving flight itineraries associated with the travel request;
second computer instruction means for converting the flight itineraries into a fare domain to create fair combinations;
third computer instruction means for comparing at least one first fare restriction associated with each fare combination to the travel request;
fourth computer instruction means for discarding fare combinations that do not comply with the travel request to create a subset of fare combinations;
fifth computer instruction means for ranking the subset of fare combinations based on one or more selected criteria; and
sixth computer instruction means for processing each fare combination one at a time to determine which flight itineraries for the travel request are covered by the fare combination.

34. A computer program product according to claim 33, wherein the selected criteria is price and said fifth computer instruction means ranks the subset of fares based on price.

35. A computer program procut according to claim 34, wherein said fifth computer instruction means determines a list of lowest priced fare combinations and creates a queue listing the fare combinations from lowest in price to highest in price, and wherein said sixth computer instruction means processes each fare combination in the queue starting with the lowest priced fare in the queue until all flight itineraries for the selected departure-return date combination are covered by at least one fare combination.

36. A computer program product according to claim 33, wherein the selected criteria is number of stops and said fifth computer instruction means ranks the subset of fares based on the number of stops associated with each fare.

37. A computer program product according to claim 33, wherein said fifth computer instruction means determines a list of fare combinations and creates a queue listing the fare combinations based on the one or more selected criteria, and wherein said sixth computer instruction means processes each fare combination in the queue starting with the first fare combination in the queue until all flight itineraries for the travel request are covered by at least one fare combination.

38. A computer program product according to claim 33, wherein the travel request includes a selected departure-return date combination, wherein said third computer instruction mean compares fare restrictions associated with each fare combination to at least the dates of the selected departure-return date combination, and said sixth computer instruction means discards fare combinations that do not comply with at least the dates of the selected departure-return date combination to create a subset of fare combinations.

39. A computer program product according to claim 33, wherein said first instruction means further:
compares at least one second fare restriction associated with each fare combination to the travel request; and
discardes fare combinations that do not comply with the travel request.

40. A computer program product according to claim 33, wherein the one or more first fare restrictions are fare level restrictions associated with the fare.

41. A computer program product according to claim 40, wherein the at least one second fare restriction is a flight level restriction associated with the fare.

42. A computer program product according to claim 33, wherein each fare template represents a pattern of fare components with respective airlines that meets the user's travel request, said computer program product further comprising for each fare template, instruction means for creating a count of the number of flight itineraries that correspond to the given fare template.

43. A computer program code according to claim 42 further comprising computer instruction means for decrementing a counter associated with a fare template, when a flight itinerary corresponding to the fare template is matched with a fare combination.

44. A computer program code according to claim 42, wherein said sixth computer instruction means for each fare combination determines the fare template corresponding to the fare combination and determines the value of the counter associated with the corresponding fare template, wherein if the counter value is zero, said suxth computer instruction means discards the fare combination without further processing.

45. A computer program prodcut according to claim 33, wherein the travel request is for a selected departure-return date combination, wherein said sixth computer instruction means processes each fare combination one at a time to determine which flight itineraries for the selected departure-return data combination are covered by the fare combination.

46. A computer program product according to claim 45 further comprising instruction means for displaying in a grid fare prices representing different flight itineraries for the selected departure-return date combination.

47. A computer program product according to claim 33, wherein the travel request is for a range of selected departure-return date combinations, wherein said sixth computer instruction means processes each fare combination one at a time to determine which flight itineraries for the selected departure-return date combinations are covered by the fare combination.

48. A computer program product according to claim 47 further comprising instruction means for displaying in a grid fare prices representing different flight itineraries for the selected departure-return date combination.
